(19) United States
(12) Patent Application Publication
(10) Pub. No.: US 2026/0220533 A1
(43) Pub. Date: Jul. 30, 2026

(54) System, Method, and Computer Program Product for Determining Feature Importance

(71) Applicant: Visa International Service Association, San Francisco, CA (US)

(72) Inventors: Yuzhong Chen, Foster City, CA (US); Mahashweta Das, Campbell, CA (US); Hao Yang, San Jose, CA (US)

(21) Appl. No.: 19/143,495

(22) PCT Filed: Dec. 27, 2022
(86) PCT No.: PCT/US22/54046

§ 371 Date: Jun. 26, 2025

(51) Int. Cl. G06N 20/00; G06F 18/241

(52) U.S. Cl. CPC G06N 20/00; G06F 18/241

(57) ABSTRACT

Provided is a system that includes a processor to receive a dataset comprising a plurality of feature values of a plurality of features; determine, for each feature of the plurality of features, a plurality of sequence deviation metrics; generate a plurality of sets of features for the plurality of sequence deviation metrics, wherein each set of features comprises a ranked set of features for a sequence deviation metric; train a plurality of machine learning models based on the plurality of sets of features, wherein the plurality of machine learning models comprises a machine learning model for each sequence deviation metric; determine a performance metric of each trained machine learning model for each sequence deviation metric; and select a ranked set of features for a sequence deviation metric that corresponds to a trained machine learning model that has a highest performance metric. Methods and computer program products are also provided.

### CROSS-REFERENCE TO RELATED APPLICATION

This application is the United States national phase of International Application No. PCT/US22/54046, filed Dec. 27, 2022, the disclosure of which is hereby incorporated by reference in its entirety.

### BACKGROUND

### 1. Technical Field

The present disclosure relates generally to features of machine learning models and, in some non-limiting embodiments or aspects, to systems, methods, and computer program products for determining the importance of features of a machine learning model.

### 2. Technical Considerations

Machine learning may be a field of computer science that uses statistical techniques to provide a computer system with the ability to learn (e.g., to progressively improve performance of) a task with data without the computer system being explicitly programmed to perform the task. In some instances, a machine learning model may be developed for a set of data so that the machine learning model may perform a task (e.g., a task associated with a prediction) with regard to the set of data.

A feature of a machine learning model may include an attribute (e.g., a characteristic, a property, and/or the like) shared by all independent units of a dataset on which analysis is to be performed by the machine learning model. The feature may have a value, such as a numerical value, associated with the attribute. In addition, feature importance may refer to a measurement of a contribution that a feature makes to an output of the analysis, such as a prediction or a classification, of the machine learning model. Feature importance may be used to understand behavior of the machine learning model, to detect errors in a dataset to avoid potential failures during implementation of the machine learning model, and to validate a governance process associated with the machine learning model.

In some instances, the importance of a feature of a machine learning model may be obtained by changing a value of the feature (e.g., by removing a value of the feature to provide a value of 0 for the feature in each data record of the dataset or by replacing the values of the feature in each data record of the dataset with a single value, such as a value of 1) in each data record of a dataset to provide a modified dataset, and the machine learning model may be re-trained using the modified dataset. A performance of the re-trained machine learning model for the feature may be determined based on evaluation data.

However, re-training a machine learning model when each feature of a plurality of features in a dataset is changed may take an enormous amount of time. This may be especially true with deep learning models that are known to, in some instances, extend training time and rely on a large number of input features. In addition, the machine learning model may need to be re-trained more than once when each feature of the plurality of features in the dataset is changed to ensure that results are properly obtained.

### SUMMARY

Accordingly, provided are improved systems, devices, products, apparatus, and/or methods for determining the importance of features of a machine learning model.

According to some non-limiting embodiments or aspects, provided is a system, comprising: at least one processor programmed or configured to: receive a dataset comprising a plurality of feature values of a plurality of features; determine, for each feature of the plurality of features, a plurality of sequence deviation metrics for a first classification and a second classification of the feature; generate a plurality of sets of features for the plurality of sequence deviation metrics, wherein each set of features comprises a ranked set of features for a sequence deviation metric of the plurality of sequence deviation metrics, and wherein each ranked set of features comprises each feature of the set of features ranked according to the sequence deviation metric; train a plurality of machine learning models based on the plurality of sets of features, wherein the plurality of machine learning models comprises a machine learning model for each sequence deviation metric, and wherein, when training the plurality of machine learning models, the at least one processor is programmed or configured to: train each of the plurality of machine learning models based on each of the ranked set of features for each sequence deviation metric of the plurality of sequence deviation metrics; determine a performance metric of each trained machine learning model for each sequence deviation metric; and select a ranked set of features for a sequence deviation metric that corresponds to a trained machine learning model that has a highest performance metric.

According to some non-limiting embodiments or aspects, provided is a computer-implemented method, comprising: receiving, with at least one processor, a dataset comprising a plurality of feature values of a plurality of features; determining, with at least one processor and for each feature of the plurality of features, a plurality of sequence deviation metrics for a first classification and a second classification of the feature; generating, with at least one processor, a plurality of sets of features for the plurality of sequence deviation metrics, wherein each set of features comprises a ranked set of features for a sequence deviation metric of the plurality of sequence deviation metrics, and wherein each ranked set of features comprises each feature of the set of features ranked according to the sequence deviation metric; training, with at least one processor, a plurality of machine learning models based on the plurality of sets of features, wherein the plurality of machine learning models comprises a machine learning model for each sequence deviation metric, and wherein training the plurality of machine learning models comprises: training each of the plurality of machine learning models based on each of the ranked set of features for each sequence deviation metric of the plurality of sequence deviation metrics; determining, with at least one processor, a performance metric of each trained machine learning model for each sequence deviation metric; and selecting, with at least one processor, a ranked set of features for a sequence deviation metric that corresponds to a trained machine learning model that has a highest performance metric.

According to some non-limiting embodiments or aspects, provided is a computer program product comprising at least one non-transitory computer-readable medium including one or more instructions that, when executed by at least one processor, cause the at least one processor to: receive a dataset comprising a plurality of feature values of a plurality of features; determine, for each feature of the plurality of features, a plurality of sequence deviation metrics for a first classification and a second classification of the feature; generate a plurality of sets of features for the plurality of sequence deviation metrics, wherein each set of features comprises a ranked set of features for a sequence deviation metric of the plurality of sequence deviation metrics, and wherein each ranked set of features comprises each feature of the set of features ranked according to the sequence deviation metric; train a plurality of machine learning models based on the plurality of sets of features, wherein the plurality of machine learning models comprises a machine learning model for each sequence deviation metric, and wherein, the one or more instructions that cause the at least one processor to train the plurality of machine learning models, cause the at least one processor to: train each of the plurality of machine learning models based on each of the ranked set of features for each sequence deviation metric of the plurality of sequence deviation metrics; determine a performance metric of each trained machine learning model for each sequence deviation metric; and select a ranked set of features for a sequence deviation metric that corresponds to a trained machine learning model that has a highest performance metric.

Further non-limiting embodiments or aspects are set forth in the following numbered clauses:
Clause 1: A system, comprising: at least one processor programmed or configured to: receive a dataset comprising a plurality of feature values of a plurality of features; determine, for each feature of the plurality of features, a plurality of sequence deviation metrics for a first classification and a second classification of the feature; generate a plurality of sets of features for the plurality of sequence deviation metrics, wherein each set of features comprises a ranked set of features for a sequence deviation metric of the plurality of sequence deviation metrics, and wherein each ranked set of features comprises each feature of the set of features ranked according to the sequence deviation metric; train a plurality of machine learning models based on the plurality of sets of features, wherein the plurality of machine learning models comprises a machine learning model for each sequence deviation metric, and wherein, when training the plurality of machine learning models, the at least one processor is programmed or configured to: train each of the plurality of machine learning models based on each of the ranked set of features for each sequence deviation metric of the plurality of sequence deviation metrics; determine a performance metric of each trained machine learning model for each sequence deviation metric; and select a ranked set of features for a sequence deviation metric that corresponds to a trained machine learning model that has a highest performance metric.
Clause 2: The system of clause 1, wherein the at least one processor is further programmed or configured to: select a first number of features from a first ranked set of features to provide a first selected set of features for a first sequence deviation metric; and select a second number of features from a second ranked set of features to provide a second selected set of features for a second sequence deviation metric; wherein, when training the plurality of machine learning models, the at least one processor is programmed or configured to: train the machine learning model of the plurality of machine learning models based on: the first selected set of features for the first sequence deviation metric, and the second selected set of features for the second sequence deviation metric.
Clause 3: The system of clauses 1 or 2, wherein the first number of features and the second number of features correspond to an input vector size of the machine learning model.
Clause 4: The system of any of clauses 1-3, wherein the at least one processor is further programmed or configured to: perform a redundancy reduction procedure on the plurality of features to provide a reduced set of features; and wherein, when determining, for each feature of the plurality of features, the plurality of sequence deviation metrics for the first classification and the second classification of the feature, the at least one processor is programmed or configured to: determine, for each feature of the reduced set of features, a plurality of sequence deviation metrics for the first classification of the feature and a plurality of sequence deviation metrics for the second classification of the feature.
Clause 5: The system of any of clauses 1-4, wherein, when determining, for each feature of the plurality of features, the plurality of sequence deviation metrics for the first classification and the second classification of the feature, the at least one processor is programmed or configured to: determine a relative cluster distance for each feature of the plurality of features, wherein, when determining the relative cluster distance for each feature of the plurality of features, the at least one processor is programmed or configured to: determine a first cluster center for a first cluster of the first classification of a feature, determine a second cluster center for a second cluster of the second classification of the feature, determine a distance between the first cluster center and the second cluster center, and divide the distance by a sum of standard deviations of the first cluster and the second cluster to provide the relative cluster distance for the feature.
Clause 6: The system of any of clauses 1-5, wherein the plurality of sequence deviation metrics comprises at least one of the following: root mean square error (RMSE); mean absolute error (MAE); mean squared error (MSE); mean absolute percentage error (MAPE); symmetric mean absolute percentage error (SMAPE); or any combination thereof.
Clause 7: The system of any of clauses 1-6, wherein the machine learning model is a binary classification machine learning model.
Clause 8: A computer-implemented method, comprising: receiving, with at least one processor, a dataset comprising a plurality of feature values of a plurality of features; determining, with at least one processor and for each feature of the plurality of features, a plurality of sequence deviation metrics for a first classification and a second classification of the feature; generating, with at least one processor, a plurality of sets of features for the plurality of sequence deviation metrics, wherein each set of features comprises a ranked set of features for a sequence deviation metric of the plurality of sequence deviation metrics, and wherein each ranked set of features comprises each feature of the set of features ranked according to the sequence deviation metric; training, with at least one processor, a plurality of machine learning models based on the plurality of sets of features, wherein the plurality of machine learning models comprises a machine learning model for each sequence deviation metric, and wherein training the plurality of machine learning models comprises: training each of the plurality of machine learning models based on each of the ranked set of features for each sequence deviation metric of the plurality of sequence deviation metrics; determining, with at least one processor, a performance metric of each trained machine learning model for each sequence deviation metric; and selecting, with at least one processor, a ranked set of features for a sequence deviation metric that corresponds to a trained machine learning model that has a highest performance metric.
Clause 9: The computer-implemented method of clause 8, further comprising: selecting a first number of features from a first ranked set of features to provide a first selected set of features for a first sequence deviation metric; and selecting a second number of features from a second ranked set of features to provide a second selected set of features for a second sequence deviation metric; wherein separately training a machine learning model comprises: separately training the machine learning model based on: the first selected set of features for the first sequence deviation metric, and the second selected set of features for the second sequence deviation metric.
Clause 10: The computer-implemented method of clauses 8 or 9, wherein the first number of features and the second number of features correspond to an input vector size of the machine learning model.
Clause 11: The computer-implemented method of any of clauses 8-10, further comprising: performing, with at least one processor, redundancy reduction procedure on the plurality of features to provide a reduced set of features; and wherein determining, for each feature of the plurality of features, the plurality of sequence deviation metrics for the first classification and the second classification of the feature comprises: determining, for each feature of the reduced set of features, a plurality of sequence deviation metrics for the first classification and the second classification of the feature.
Clause 12: The computer-implemented method of any of clauses 8-11, wherein determining, for each feature of the plurality of features, the plurality of sequence deviation metrics for the first classification and the second classification of the feature comprises: determining a relative cluster distance for each feature of the plurality of features, wherein determining a relative cluster distance for each feature of the plurality of features comprises: determining a first cluster center for a first cluster of the first classification of a feature, determining a second cluster center for a second cluster of the second classification of the feature, determining a distance between the first cluster center and the second cluster center, and dividing the distance by a sum of standard deviations of the first cluster and the second cluster to provide the relative cluster distance for the feature.
Clause 13: The computer-implemented method of any of clauses 8-12, wherein the plurality of sequence deviation metrics comprises one or more of the following: root mean square error (RMSE); mean absolute error (MAE); mean squared error (MSE); mean absolute percentage error (MAPE); symmetric mean absolute percentage error (SMAPE); or any combination thereof.
Clause 14: The computer-implemented method of any of clauses 8-13, wherein the machine learning model is a binary classification machine learning model.
Clause 15: A computer program product, the computer program product comprising at least one non-transitory computer-readable medium including one or more instructions that, when executed by at least one processor, cause the at least one processor to: receive a dataset comprising a plurality of feature values of a plurality of features; determine, for each feature of the plurality of features, a plurality of sequence deviation metrics for a first classification and a second classification of the feature; generate a plurality of sets of features for the plurality of sequence deviation metrics, wherein each set of features comprises a ranked set of features for a sequence deviation metric of the plurality of sequence deviation metrics, and wherein each ranked set of features comprises each feature of the set of features ranked according to the sequence deviation metric; train a plurality of machine learning models based on the plurality of sets of features, wherein the plurality of machine learning models comprises a machine learning model for each sequence deviation metric, and wherein, the one or more instructions that cause the at least one processor to train the plurality of machine learning models, cause the at least one processor to: train each of the plurality of machine learning models based on each of the ranked set of features for each sequence deviation metric of the plurality of sequence deviation metrics; determine a performance metric of each trained machine learning model for each sequence deviation metric; and select a ranked set of features for a sequence deviation metric that corresponds to a trained machine learning model that has a highest performance metric.
Clause 16: The computer program product of clause 15, wherein the one or more instructions further cause the at least one processor to: select a first number of features from a first ranked set of features to provide a first selected set of features for a first sequence deviation metric; and select a second number of features from a second ranked set of features to provide a second selected set of features for a second sequence deviation metric; wherein, the one or more instructions that cause the at least one processor to train the plurality of machine learning models, cause the at least one processor to: train the machine learning model of the plurality of machine learning models based on: the first selected set of features for the first sequence deviation metric, and the second selected set of features for the second sequence deviation metric.
Clause 17: The computer program product of clauses 15 or 16, wherein the first number of features and the second number of features correspond to an input vector size of the machine learning model.
Clause 18: The computer program product of any of clauses 15-17, wherein the one or more instructions further cause the at least one processor to: perform redundancy reduction procedure on the plurality of features to provide a reduced set of features; and wherein, the one or more instructions that cause the at least one processor to determine, for each feature of the plurality of features, the plurality of sequence deviation metrics for the first classification and the second classification of the feature, cause the at least one processor to: determine, for each feature of the reduced set of features, a plurality of sequence deviation metrics for the first classification of the feature and a plurality of sequence deviation metrics for the second classification of the feature.
Clause 19: The computer program product of any of clauses 15-18, wherein, the one or more instructions that cause the at least one processor to determine, for each feature of the plurality of features, the plurality of sequence deviation metrics for the first classification and the second classification of the feature, cause the at least one processor to: determine a relative cluster distance for each feature of the plurality of features, wherein, the one or more instructions that cause the at least one processor to determine the relative cluster distance for each feature of the plurality of features, cause the at least one processor to: determine a first cluster center for a first cluster of the first classification of a feature, determine a second cluster center for a second cluster of the second classification of the feature, determine a distance between the first cluster center and the second cluster center, and divide the distance by a sum of standard deviations of the first cluster and the second cluster to provide the relative cluster distance for the feature.
Clause 20: The computer program product of any of clauses 15-19, wherein the plurality of sequence deviation metrics comprises at least one of the following: root mean square error (RMSE); mean absolute error (MAE); mean squared error (MSE); mean absolute percentage error (MAPE); symmetric mean absolute percentage error (SMAPE); or any combination thereof.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments that are illustrated in the accompanying schematic figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices of FIG. 1;

FIG. 3 is a flowchart of a non-limiting embodiment or aspect of a process for determining the importance of features of a machine learning model; and

FIGS. 4A-4F are diagrams of non-limiting embodiments or aspects of an implementation of a process for determining the importance of features of a machine learning model.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments or aspects, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa@, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments or aspects, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments or aspects, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Non-limiting embodiments or aspects of the present disclosure are directed to systems, methods, and computer program products for determining the importance of features of a machine learning model. In some non-limiting embodiments or aspects, a feature management system may receive a dataset comprising a plurality of feature values of a plurality of features, determine, for each feature of the plurality of features, a plurality of sequence deviation metrics for a first classification and a second classification of the feature, generate a plurality of sets of features for the plurality of sequence deviation metrics. In some non-limiting embodiments or aspects, each set of features may include a ranked set of features for a sequence deviation metric of the plurality of sequence deviation metrics and each ranked set of features may include each feature of the set of features ranked according to the sequence deviation metric.

In some non-limiting embodiments or aspects, a feature management system may train a plurality of machine learning models based on the plurality of sets of features, where the plurality of machine learning models may include a machine learning model for each sequence deviation metric and, when training the plurality of machine learning models, the feature management system may train each of the plurality of machine learning models based on each of the ranked set of features for each sequence deviation metric of the plurality of sequence deviation metrics. In some non-limiting embodiments or aspects, feature management system may determine a performance metric of each trained machine learning model for each sequence deviation metric and select a ranked set of features for a sequence deviation metric that corresponds to a trained machine learning model that has a highest performance metric.

In some non-limiting embodiments or aspects, the feature management system may select a first number of features from a first ranked set of features to provide a first selected set of features for a first sequence deviation metric, select a second number of features from a second ranked set of features to provide a second selected set of features for a second sequence deviation metric, and when training the plurality of machine learning models, the feature management system may train a machine learning model of the plurality of machine learning models based on the first selected set of features for the first sequence deviation metric, and the second selected set of features for the second sequence deviation metric. In some non-limiting embodiments or aspects, the first number of features and the second number of features correspond to an input vector size of the machine learning model.

In some non-limiting embodiments or aspects, the feature management system may perform a redundancy reduction procedure on the plurality of features to provide a reduced set of features, and when determining, for each feature of the plurality of features, the plurality of sequence deviation metrics for the first classification and the second classification of the feature, the feature management system may determine, for each feature of the reduced set of features, a plurality of sequence deviation metrics for the first classification of the feature and a plurality of sequence deviation metrics for the second classification of the feature.

In some non-limiting embodiments or aspects, when determining, for each feature of the plurality of features, the plurality of sequence deviation metrics for the first classification and the second classification of the feature, the feature management system may determine a relative cluster distance for each feature of the plurality of features, wherein, when determining the relative cluster distance for each feature of the plurality of features, the feature management system may determine a first cluster center for a first cluster of the first classification of a feature, determine a second cluster center for a second cluster of the second classification of the feature, determine a distance between the first cluster center and the second cluster center, and divide the distance by a sum of standard deviations of the first cluster and the second cluster to provide the relative cluster distance for the feature. In some non-limiting embodiments or aspects, the plurality of sequence deviation metrics may include at least one of the following root mean square error (RMSE), mean absolute error (MAE), mean squared error (MSE), mean absolute percentage error (MAPE), symmetric mean absolute percentage error (SMAPE), relative cluster distance (RCD), or any combination thereof. In some non-limiting embodiments or aspects, the machine learning model is a binary classification machine learning model.

In this way, the feature management system may provide for determining feature importance of at least one feature of a machine learning model independent of multiple rounds of re-training the machine learning model for each feature of a plurality of features in a dataset. In addition, non-limiting embodiments of the present disclosure may more accurately determine feature importance of the at least one feature of the machine learning model independent than re-training the machine learning model more than once for each feature of the plurality of features in the dataset. Further, features that are determined to be less important than other features may be removed before training a machine learning model, and the accuracy of a machine learning model may be improved, while simultaneously reducing the runtime for one or more actions performed using the machine learning model.

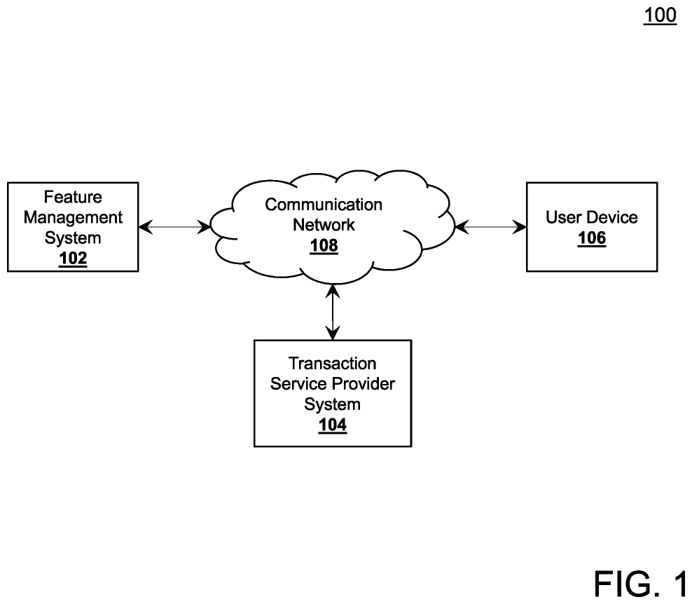

Referring now to FIG. 1, FIG. 1 is a diagram of an example environment 100 in which devices, systems, and/or methods, described herein, may be implemented. As shown in FIG. 1, environment 100 may include feature management system 102, transaction service provider system 104, user device 106, and communication network 108. Feature management system 102, transaction service provider system 104, and/or user device 106 may interconnect (e.g., establish a connection to communicate) via wired connections, wireless connections, or a combination of wired and wireless connections.

Feature management system 102 may include one or more devices configured to communicate with transaction service provider system 104 and/or user device 106 via communication network 108. For example, feature management system 102 may include a server, a group of servers, and/or other like devices. In some non-limiting embodiments or aspects, feature management system 102 may be associated with a transaction service provider system (e.g., may be operated by a transaction service provider as a component of a transaction service provider system, may be operated by a transaction service provider independent of a transaction service provider system, etc.), as described herein. Additionally or alternatively, feature management system 102 may generate (e.g., train, validate, re-train, and/or the like), store, and/or implement (e.g., operate, provide inputs to and/or outputs from, and/or the like) one or more machine learning models. For example, feature management system 102 may generate one or more machine learning models by fitting (e.g., validating) one or more machine learning models against data used for training (e.g., training data). In some non-limiting embodiments or aspects, feature management system 102 may generate, store, and/or implement one or more machine learning models, such as one or more machine learning models that are provided for a production environment (e.g., a real-time or runtime environment used for providing inferences based on data in a live situation). In some non-limiting embodiments or aspects, feature management system 102 may be in communication with a data storage device, which may be local or remote to feature management system 102. In some non-limiting embodiments or aspects, feature management system 102 may be capable of receiving information from, storing information in, transmitting information to, and/or searching information stored in the data storage device.

Transaction service provider system 104 may include one or more devices configured to communicate with feature management system 102 and/or user device 106 via communication network 108. For example, transaction service provider system 104 may include a computing device, such as a server, a group of servers, and/or other like devices. In some non-limiting embodiments or aspects, transaction service provider system 104 may be associated with a transaction service provider system, as discussed herein. In some non-limiting embodiments or aspects, time series analysis system may be a component of transaction service provider system 104.

User device 106 may include a computing device configured to communicate with feature management system 102 and/or transaction service provider system 104 via communication network 108. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE@) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

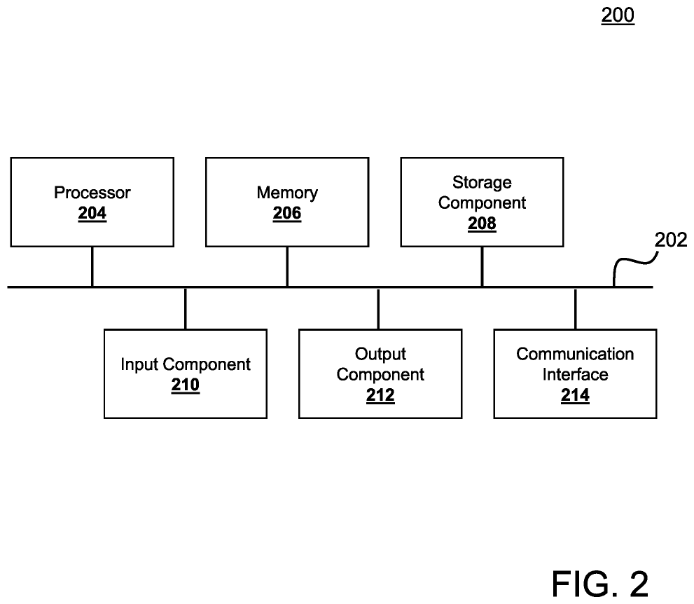

Referring now to FIG. 2, FIG. 2 is a diagram of example components of a device 200. Device 200 may correspond to feature management system 102 (e.g., one or more devices of feature management system 102), transaction service provider system 104 (e.g., one or more devices of transaction service provider system 104), and/or user device 106. In some non-limiting embodiments or aspects, feature management system 102, transaction service provider system 104, and/or user device 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

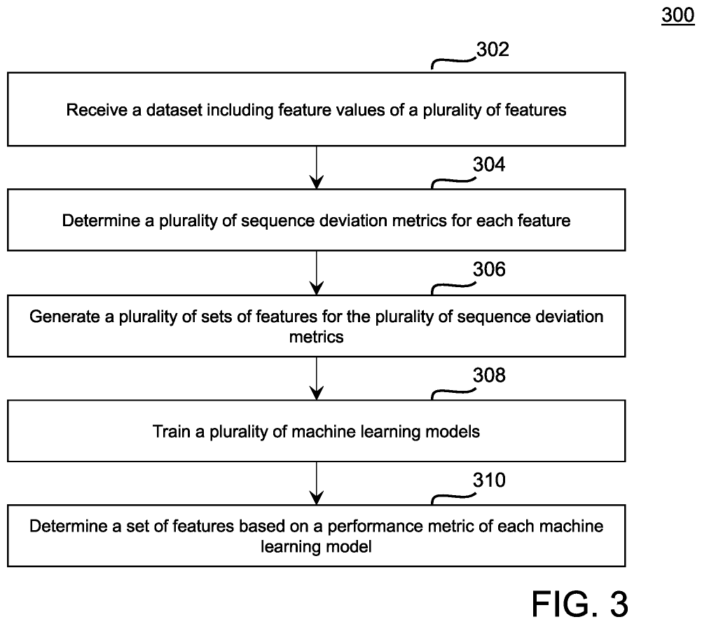

Referring now to FIG. 3, FIG. 3 is a flowchart of a non-limiting embodiment or aspect of a process 300 for determining the importance of features of a machine learning model. In some non-limiting embodiments or aspects, one or more of the steps of process 300 may be performed (e.g., completely, partially, etc.) by feature management system 102 (e.g., one or more devices of feature management system 102). In some non-limiting embodiments or aspects, one or more of the steps of process 300 may be performed (e.g., completely, partially, etc.) by another device or a group of devices separate from or including feature management system 102 (e.g., one or more devices of feature management system 102), transaction service provider system 104 (e.g., one or more devices of transaction service provider system 104), and/or user device 106.

As shown in FIG. 3, at step 302, process 300 includes receiving a dataset including feature values of a plurality of features. For example, feature management system 102 may receive a dataset including feature values of a plurality of features. In some non-limiting embodiments or aspects, feature management system 102 may receive the dataset from an external system, such as an issuer system, a merchant system, a transaction service provider system, and/or the like. In some non-limiting embodiments or aspects, a feature value of a feature may correspond to a value of transaction data associated with a payment transaction. For example, the feature value of a feature may correspond to a value of a data field in a record of a payment transaction.

In some non-limiting embodiments or aspects, the plurality of features may include one or more features that correspond to transaction data (e.g., a parameter of transaction data, such as a data field in a record of a payment transaction) associated with a payment transaction. For example, the plurality of features may include a transaction amount associated with an amount of the payment transaction (e.g., a cost associated with the payment transaction, a transaction amount, an overall transaction amount, a cost of one or more products involved in the payment transaction, and/or the like), a transaction value associated with a number of payment transactions, a transaction time associated with a time interval at which the payment transaction occurred (e.g., a timestamp that includes a time of day, a day of the week, a date of a month, a month of a year, a predetermined time of day segment such as morning, afternoon, evening, night, and/or the like, a predetermined day of the week segment such as weekday, weekend, and/or the like, a predetermined segment of a year such as first quarter, second quarter, and/or the like), a transaction type of the payment transaction (e.g., an online transaction, a card present transaction, a face-to-face transaction, an electronic commerce indicator, a settlement flag for a payment transaction, and/or the like), an account identifier (e.g., a PAN) of an account involved in the payment transaction, a merchant identifier (e.g., a merchant name) of a merchant involved in the payment transaction, a merchant category code of a merchant involved in the payment transaction, and/or the like.

In some non-limiting embodiments or aspects, the transaction data associated with the payment transactions may include values of a plurality of data fields associated with the payment transactions. The values of the plurality of data fields may include values of one or more transaction amount data fields associated with an amount of the payment transaction (e.g., a cost associated with the payment transaction, a transaction amount, an overall transaction amount, a cost of one or more products involved in the payment transaction, and/or the like), values of one or more transaction time data fields associated with a time interval at which the payment transaction occurred (e.g., a time of day, a day of the week, a date of a month, a month of a year, a predetermined time of day segment such as morning, afternoon, evening, night, and/or the like, a predetermined day of the week segment such as weekday, weekend, and/or the like, a predetermined segment of a year such as first quarter, second quarter, and/or the like), values of one or more transaction type data fields associated with a transaction type of the payment transaction (e.g., an online transaction, a card present transaction, a face-to-face transaction, an electronic commerce indicator, a settlement flag for a payment transaction, and/or the like), and/or the like.

In some non-limiting embodiments or aspects, feature management system 102 may perform a redundancy reduction procedure on the dataset to provide a dataset with a reduced number of features. For example, feature management system 102 may receive an initial dataset with an initial number of features and feature management system 102 may perform the redundancy reduction procedure on the initial dataset to provide a revised dataset that has a revised number of features, where the revised number of features is less than the initial number of features. In some non-limiting embodiments or aspects, the redundancy reduction procedure may include a technique that reduces redundant features. A technique that reduces redundant features may include a correlation-analysis-based redundancy reduction technique that is based on a correlation coefficient. In some non-limiting embodiments or aspects, correlation coefficient may include the Pearson correlation coefficient and/or the Spearman rank correlation coefficient.

In some non-limiting embodiments or aspects, feature management system 102 may generate one or more sequences of feature values (e.g., one or more sequences of feature values over a time period) of a feature from a dataset that includes a plurality of feature values of a plurality of features. In some non-limiting embodiments or aspects, a sequence of feature values may include a plurality of values of a first feature over a time period that are provided in reference to a specific value of a second feature. For example, a sequence of feature values may include a sequence of values of transaction volume of payment transactions over a time period in reference to a specific value of transaction amount of the payment transactions. In some non-limiting embodiments or aspects, feature management system 102 may apply a weighting procedure and/or a normalization procedure to a plurality of feature values of a plurality of features and feature management system 102 may generate one or more sequences of feature values based on applying the weighting procedure and/or the normalization procedure.

In some non-limiting embodiments or aspects, feature management system 102 may generate a sequence of feature values for one or more classifications of a feature. For example, feature management system 102 may generate a sequence of feature values for a first classification of a feature, a second sequence of feature values for a second classification of the feature, and/or the like. In some non-limiting embodiments or aspects, a classification of a feature may include a classification based on an output of a machine learning model. For example, the classification of the feature may include a positive classification based on an output of a machine learning model that indicates a positive prediction (e.g., a prediction that an event will occur). In another example, the classification of the feature may include a negative classification based on an output of a machine learning model that indicates a negative prediction (e.g., a prediction that an event will not occur). In some non-limiting embodiments or aspects, feature management system 102 may generate one or more sequences of feature values over a time period for each classification of a feature in reference to another feature.

In some non-limiting embodiments or aspects, feature management system 102 may generate a first sequence of feature values for a first classification of a feature (e.g., a feature in reference to another feature) and a second sequence of feature values for a second classification of the feature. For example, the plurality of feature values may include a first sequence of feature values for a positive classification of a feature and a second sequence of feature values for a negative classification of the feature.

As shown in FIG. 3, at step 304, process 300 includes determining a plurality of sequence deviation metrics for each feature. For example, feature management system 102 may determine a plurality of sequence deviation metrics for each feature of a plurality of features. A sequence deviation metric may include a metric that provides a measurement of difference between feature values of a first sequence and feature values of a second sequence. In some non-limiting embodiments or aspects, the plurality of sequence deviation metrics may include root mean square error (RMSE), mean absolute error (MAE), mean squared error (MSE), mean absolute percentage error (MAPE), symmetric mean absolute percentage error (SMAPE), relative cluster distance (RCD), and/or the like. In some non-limiting embodiments or aspects, feature management system 102 may determine a sequence deviation metric (e.g., each sequence deviation metric of a plurality of sequence deviation metrics) for a feature (e.g., each feature of a plurality of features) by determining a value of the sequence deviation metric based on a first sequence of feature values for a first classification of a feature and a second sequence of feature values for a second classification of that feature.

In some non-limiting embodiments or aspects, feature management system 102 may determine a RCD for each feature of the plurality of features. For example, feature management system 102 may determine a plurality of clusters (e.g., based on a clustering algorithm, such as K-means clustering) for a feature. Feature management system 102 may determine a first cluster center for a first cluster of a first classification of a feature and a second cluster center for a second cluster of the second classification of the feature, and feature management system 102 may determine a distance between the first cluster center and the second cluster center. Feature management system 102 may divide the distance by a sum of standard deviations of the first cluster and the second cluster to provide a value of the RCD for the feature.

As shown in FIG. 3, at step 306, process 300 includes generating a plurality of sets of features for the plurality of sequence deviation metrics. For example, feature management system 102 may generate a plurality of sets of features for the plurality of sequence deviation metrics. In some non-limiting embodiments or aspects, feature management system 102 may generate a set of features for each sequence deviation metric of the plurality of sequence deviation metrics based on a first classification and a second classification of each feature of a plurality of features. For example, feature management system 102 may calculate each sequence deviation metric of the plurality of sequence deviation metrics based on feature values of a first classification and a second classification of each feature of a plurality of features, and feature management system 102 may generate a set of features for each sequence deviation metric. In some non-limiting embodiments or aspects, a set of features may include a value of a sequence deviation metric for each feature of the plurality of features.

In some non-limiting embodiments or aspects, a set of features for a sequence deviation metric may include a ranked set of features for the sequence deviation metric, where the ranked set of features may include each feature of the set of features ranked according to the sequence deviation metric (e.g., the value of the sequence deviation metric for a feature). Additionally or alternatively, a set of features for a sequence deviation metric may include a reduced set of features, where the reduced set of features may include a set of features that satisfy a threshold value for a sequence deviation metric. For example, the reduced set of features may include a set of features that satisfy a threshold value of the highest values for the sequence deviation metric, such as the highest 10%, 20%, 30%, and/or the like, of features for the sequence deviation metric.

In some non-limiting embodiments or aspects, feature management system 102 may generate a ranked set of features for a sequence deviation metric. For example, feature management system 102 may determine a value of a sequence deviation metric for each feature of a set of features, and feature management system 102 may rank each feature of the set of features based on a value of the sequence deviation metric for each feature to provide the ranked set of features for that sequence deviation metric. In such an example, each feature in the ranked set of features may be provided in order based on values of the sequence deviation metric. In some non-limiting embodiments or aspects, feature management system 102 may perform a redundancy reduction procedure on a set of features for a sequence deviation metric to provide a reduced set of features for the sequence deviation metric.

As shown in FIG. 3, at step 308, process 300 includes training a plurality of machine learning models. For example, feature management system 102 may train a plurality of machine learning models. In some non-limiting embodiments or aspects, feature management system 102 may train a machine learning model for each sequence deviation metric and feature management system 102 may train each of the plurality of machine learning models based on each set of features (e.g., each ranked set of features, each reduced set of features, etc.) for each sequence deviation metric of the plurality of sequence deviation metrics.

In some non-limiting embodiments or aspects, feature management system 102 may determine one or more performance metrics of each machine learning model that has been trained (e.g., each trained machine learning model) based on a set of features for each sequence deviation metric. For example, feature management system 102 may determine an accuracy metric, a precision metric, a recall metric, and/or the like, of each machine learning model.

As shown in FIG. 3, at step 310, process 300 includes determining a set of features based on a performance metric of each machine learning model. For example, feature management system 102 may determine a set of features based on a performance metric of each machine learning model. In some non-limiting embodiments or aspects, feature management system 102 may compare each trained machine learning model for each sequence deviation metric based on a performance metric, and feature management system 102 may select a set of features for a sequence deviation metric that corresponds to a trained machine learning model that has a highest value of the performance metric.

In some non-limiting embodiments or aspects, feature management system 102 may generate a production machine learning model based on the set of features selected by feature management system 102. For example, feature management system 102 may train and/or validate the production machine learning model based on the set of features selected by feature management system 102.

In some non-limiting embodiments or aspects, feature management system 102 may receive a request for inference for a production machine learning. In some non-limiting embodiments or aspects, the request for inference may be associated with a task for which the production machine learning model may provide an inference. In some non-limiting embodiments or aspects, the request for inference may be associated with financial service tasks. For example, the request for inference may be associated with a token service task, an authentication task (e.g., a 3D secure authentication task), a fraud detection task, and/or the like.

In some non-limiting embodiments or aspects, the request for inference may include runtime input data. In some non-limiting embodiments or aspects, the runtime input data may include a sample of data that is received by a trained machine learning model in real-time (e.g., a time at which or close to a time at which operations of a system, such as feature management system 102. are carried out) with respect to the runtime input data being generated. For example, runtime input data may be generated by a data source (e.g., a customer performing a transaction) and may be subsequently received by the trained machine learning model in real-time. Runtime (e.g., production) may refer to inputting runtime data (e.g., a runtime dataset, real-world data, real-world observations, and/or the like) into one or more trained machine learning models (e.g., one or more trained machine learning models of feature management system 102) and/or generating an inference (e.g., generating an inference using feature management system 102 or another machine learning system).

In some non-limiting embodiments or aspects, runtime may be performed during a phase which may occur after a training phase, after a testing phase, and/or after deployment of the machine learning model into a production environment. During a time period associated with the runtime phase, the machine learning model (e.g., a production machine learning model) may process the runtime input data to generate inferences (e.g., real-time inferences, real-time predictions, and/or the like).

In some non-limiting embodiments or aspects, a production machine learning model may include a machine learning model that has been trained and/or validated (e.g., tested) and that may be used to generate inferences (e.g., prediction), such as real-time inferences, runtime inferences, and/or the like.

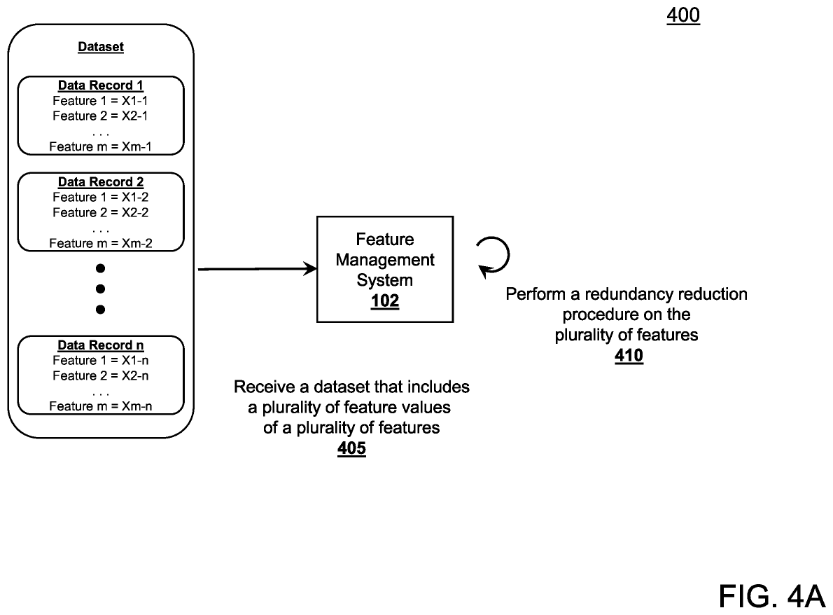

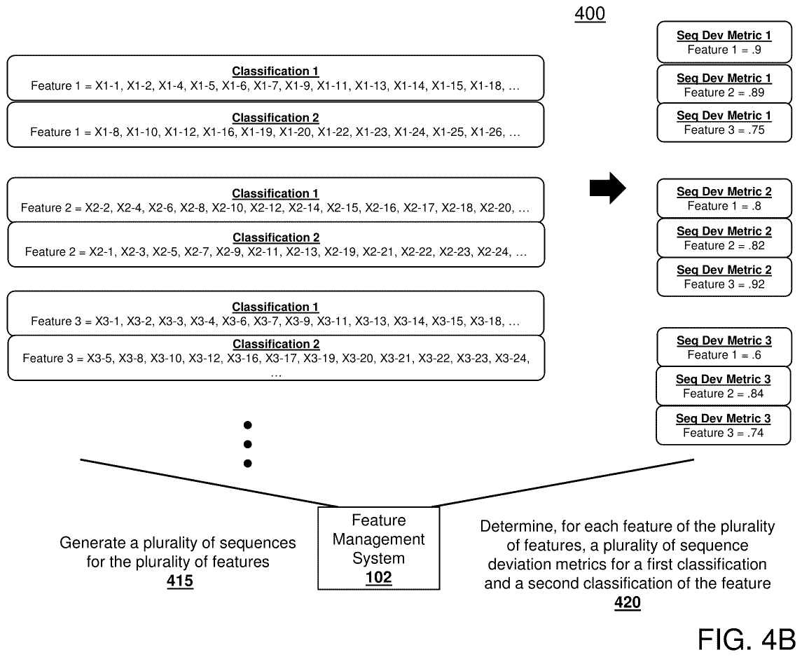

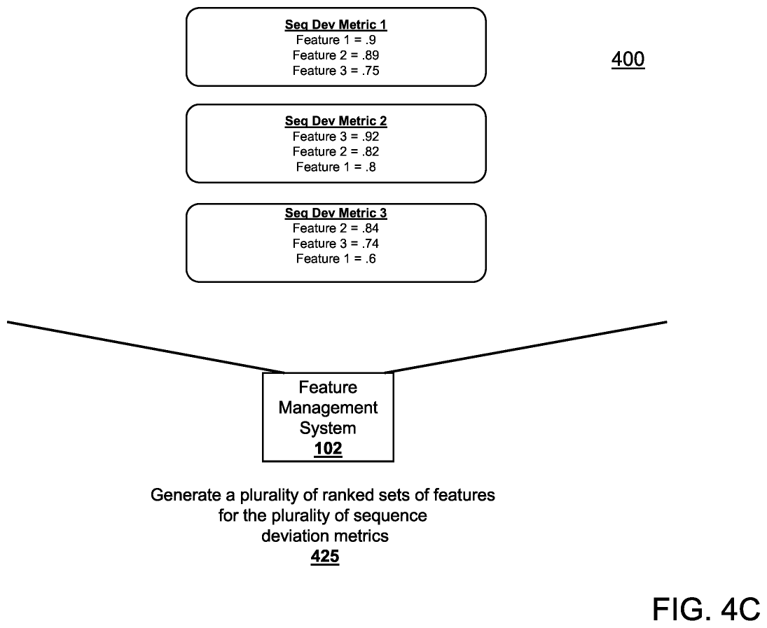

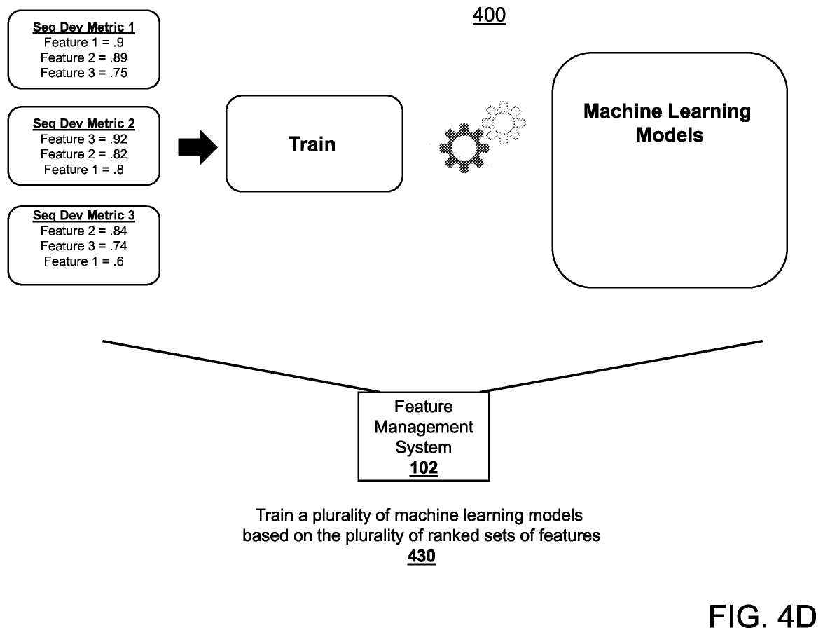

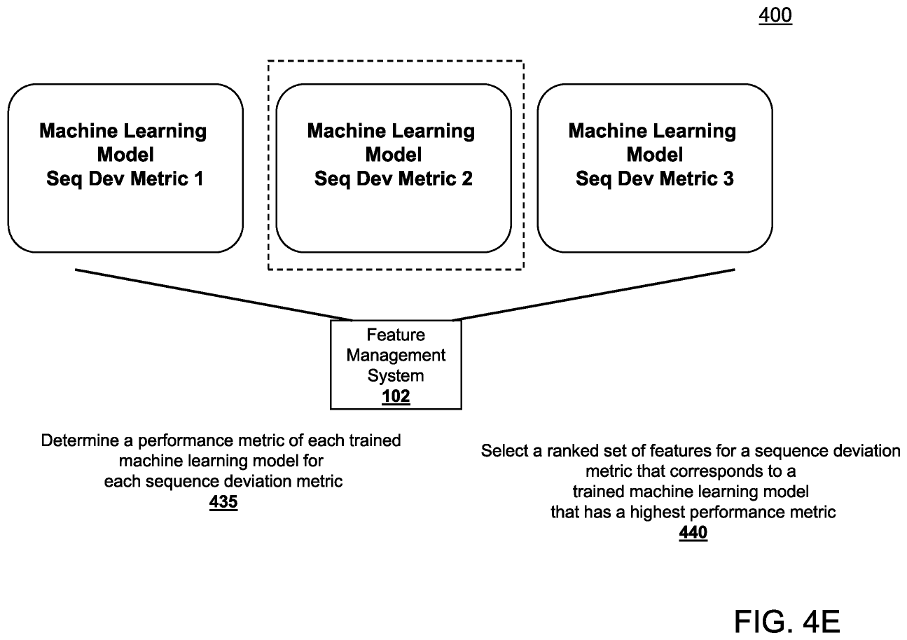

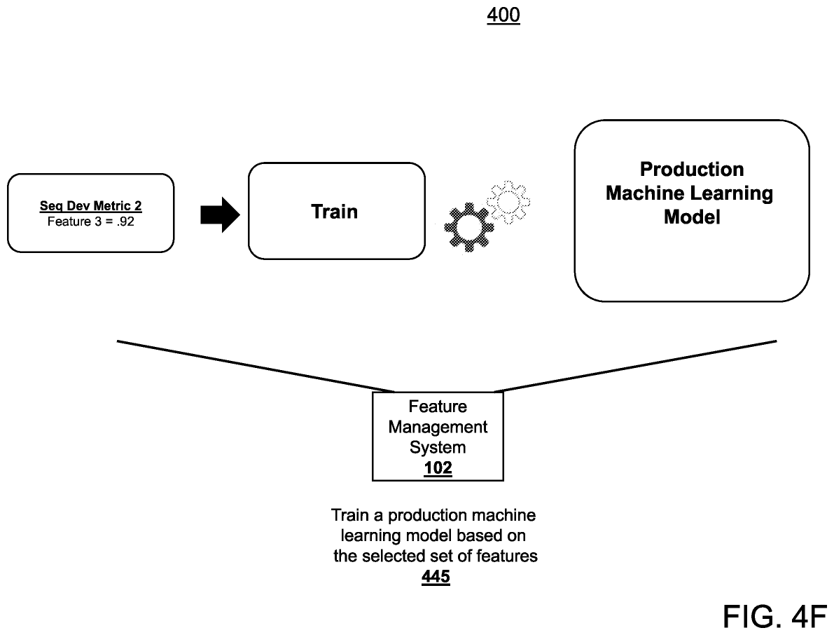

Referring now to FIGS. 4A-4F, FIGS. 4A-4F are diagrams of non-limiting embodiments or aspects of an implementation 400 of a process (e.g., process 300) for determining the importance of features of a machine learning model.

As shown by reference number 405 in FIG. 4A, feature management system 102 may receive a dataset that includes a plurality of feature values of a plurality of features. As further shown by reference number 410 in FIG. 4A, feature management system 102 may perform a redundancy reduction procedure on the plurality of features.

As shown by reference number 415 in FIG. 4B, feature management system 102 may generate a plurality of sequences for the plurality of features. For example, feature management system 102 may generate a first sequence of feature values for a first classification of a feature (e.g., a feature in reference to another feature) and a second sequence of feature values for a second classification of the feature. In one example, the plurality of feature values may include a first sequence of feature values for a positive classification of a feature and a second sequence of feature values for a negative classification of the feature. As further shown by reference number 420 in FIG. 4B, feature management system 102 may determine, for each feature of the plurality of features, a plurality of sequence deviation metrics for a first classification and a second classification of the feature. In some non-limiting embodiments or aspects, feature management system 102 may determine a sequence deviation metric (e.g., each sequence deviation metric of a plurality of sequence deviation metrics) for a feature (e.g., each feature of a plurality of features) by determining a value of the sequence deviation metric based on a first sequence of feature values for a first classification of a feature and a second sequence of feature values for a second classification of that feature. In some non-limiting embodiments or aspects, the plurality of sequence deviation metrics may include RMSE, MAE, MSE, MAPE, SMAPE, RCD, and/or the like.

As shown by reference number 425 in FIG. 4C, feature management system 102 may generate a plurality of ranked sets of features for the plurality of sequence deviation metrics. For example, feature management system 102 may generate a ranked set of features for each sequence deviation metric of the plurality of sequence deviation metrics based on a first classification and a second classification of each feature of a plurality of features.

As shown by reference number 430 in FIG. 4D, feature management system 102 may train a plurality of machine learning models based on the plurality of ranked sets of features. In some non-limiting embodiments or aspects, feature management system 102 may train a machine learning model for each sequence deviation metric and feature management system 102 may train each of the plurality of machine learning models based on each ranked set of features for each sequence deviation metric of the plurality of sequence deviation metrics.

As shown by reference number 435 in FIG. 4E, feature management system 102 may determine a performance metric of each trained machine learning model for each sequence deviation metric. As further shown by reference number 440 in FIG. 4E, feature management system 102 may select a ranked set of features for a sequence deviation metric that corresponds to a trained machine learning model that has a highest performance metric. As shown by reference number 445 in FIG. 4F, feature management system 102 may train a production machine learning model based on the selected set of features.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A system, comprising:
at least one processor programmed or configured to:
receive a dataset comprising a plurality of feature values of a plurality of features;
determine, for each feature of the plurality of features, a plurality of sequence deviation metrics for a first classification and a second classification of the feature;
generate a plurality of sets of features for the plurality of sequence deviation metrics, wherein each set of features comprises a ranked set of features for a sequence deviation metric of the plurality of sequence deviation metrics, and wherein each ranked set of features comprises each feature of the set of features ranked according to the sequence deviation metric;
train a plurality of machine learning models based on the plurality of sets of features, wherein the plurality of machine learning models comprises a machine learning model for each sequence deviation metric, and wherein, when training the plurality of machine learning models, the at least one processor is programmed or configured to:
train each of the plurality of machine learning models based on each of the ranked set of features for each sequence deviation metric of the plurality of sequence deviation metrics;
determine a performance metric of each trained machine learning model for each sequence deviation metric; and
select a ranked set of features for a sequence deviation metric that corresponds to a trained machine learning model that has a highest performance metric.

2. The system of claim 1, wherein the at least one processor is further programmed or configured to:
select a first number of features from a first ranked set of features to provide a first selected set of features for a first sequence deviation metric; and
select a second number of features from a second ranked set of features to provide a second selected set of features for a second sequence deviation metric;
wherein, when training the plurality of machine learning models, the at least one processor is programmed or configured to:
train the machine learning model of the plurality of machine learning models based on:
the first selected set of features for the first sequence deviation metric, and
the second selected set of features for the second sequence deviation metric.

3. The system of claim 2, wherein the first number of features and the second number of features correspond to an input vector size of the machine learning model.

4. The system of claim 1, wherein the at least one processor is further programmed or configured to:
perform a redundancy reduction procedure on the plurality of features to provide a reduced set of features; and
wherein, when determining, for each feature of the plurality of features, the plurality of sequence deviation metrics for the first classification and the second classification of the feature, the at least one processor is programmed or configured to:
determine, for each feature of the reduced set of features, a plurality of sequence deviation metrics for the first classification of the feature and a plurality of sequence deviation metrics for the second classification of the feature.

5. The system of claim 1, wherein, when determining, for each feature of the plurality of features, the plurality of sequence deviation metrics for the first classification and the second classification of the feature, the at least one processor is programmed or configured to:
determine a relative cluster distance for each feature of the plurality of features, wherein, when determining the relative cluster distance for each feature of the plurality of features, the at least one processor is programmed or configured to:
determine a first cluster center for a first cluster of the first classification of a feature,
determine a second cluster center for a second cluster of the second classification of the feature,
determine a distance between the first cluster center and the second cluster center, and
divide the distance by a sum of standard deviations of the first cluster and the second cluster to provide the relative cluster distance for the feature.

6. The system of claim 1, wherein the plurality of sequence deviation metrics comprises at least one of the following:
root mean square error (RMSE);
mean absolute error (MAE);
mean squared error (MSE);
mean absolute percentage error (MAPE);
symmetric mean absolute percentage error (SMAPE); or
any combination thereof.

7. The system of claim 1, wherein the machine learning model is a binary classification machine learning model.

8. A computer-implemented method, comprising:
receiving, with at least one processor, a dataset comprising a plurality of feature values of a plurality of features;
determining, with at least one processor and for each feature of the plurality of features, a plurality of sequence deviation metrics for a first classification and a second classification of the feature;
generating, with at least one processor, a plurality of sets of features for the plurality of sequence deviation metrics, wherein each set of features comprises a ranked set of features for a sequence deviation metric of the plurality of sequence deviation metrics, and wherein each ranked set of features comprises each feature of the set of features ranked according to the sequence deviation metric;
training, with at least one processor, a plurality of machine learning models based on the plurality of sets of features, wherein the plurality of machine learning models comprises a machine learning model for each sequence deviation metric, and wherein training the plurality of machine learning models comprises:
training each of the plurality of machine learning models based on each of the ranked set of features for each sequence deviation metric of the plurality of sequence deviation metrics;
determining, with at least one processor, a performance metric of each trained machine learning model for each sequence deviation metric; and
selecting, with at least one processor, a ranked set of features for a sequence deviation metric that corresponds to a trained machine learning model that has a highest performance metric.

9. The computer-implemented method of claim 8, further comprising:
selecting a first number of features from a first ranked set of features to provide a first selected set of features for a first sequence deviation metric; and
selecting a second number of features from a second ranked set of features to provide a second selected set of features for a second sequence deviation metric;
wherein separately training a machine learning model comprises:
separately training the machine learning model based on:
the first selected set of features for the first sequence deviation metric, and
the second selected set of features for the second sequence deviation metric.

10. The computer-implemented method of claim 9, wherein the first number of features and the second number of features correspond to an input vector size of the machine learning model.

11. The computer-implemented method of claim 8, further comprising:
performing, with at least one processor, redundancy reduction procedure on the plurality of features to provide a reduced set of features; and
wherein determining, for each feature of the plurality of features, the plurality of sequence deviation metrics for the first classification and the second classification of the feature comprises:
determining, for each feature of the reduced set of features, a plurality of sequence deviation metrics for the first classification and the second classification of the feature.

12. The computer-implemented method of claim 8, wherein determining, for each feature of the plurality of features, the plurality of sequence deviation metrics for the first classification and the second classification of the feature comprises:
determining a relative cluster distance for each feature of the plurality of features, wherein determining a relative cluster distance for each feature of the plurality of features comprises:
determining a first cluster center for a first cluster of the first classification of a feature,
determining a second cluster center for a second cluster of the second classification of the feature,
determining a distance between the first cluster center and the second cluster center, and
dividing the distance by a sum of standard deviations of the first cluster and the second cluster to provide the relative cluster distance for the feature.

13. The computer-implemented method of claim 8, wherein the plurality of sequence deviation metrics comprises one or more of the following:
root mean square error (RMSE);
mean absolute error (MAE);
mean squared error (MSE);
mean absolute percentage error (MAPE);
symmetric mean absolute percentage error (SMAPE); or
any combination thereof.

14. The computer-implemented method of claim 8, wherein the machine learning model is a binary classification machine learning model.

15. A computer program product, the computer program product comprising at least one non-transitory computer-readable medium including one or more instructions that, when executed by at least one processor, cause the at least one processor to:
receive a dataset comprising a plurality of feature values of a plurality of features;
determine, for each feature of the plurality of features, a plurality of sequence deviation metrics for a first classification and a second classification of the feature;
generate a plurality of sets of features for the plurality of sequence deviation metrics, wherein each set of features comprises a ranked set of features for a sequence deviation metric of the plurality of sequence deviation metrics, and wherein each ranked set of features comprises each feature of the set of features ranked according to the sequence deviation metric;
train a plurality of machine learning models based on the plurality of sets of features, wherein the plurality of machine learning models comprises a machine learning model for each sequence deviation metric, and wherein, the one or more instructions that cause the at least one processor to train the plurality of machine learning models, cause the at least one processor to:
train each of the plurality of machine learning models based on each of the ranked set of features for each sequence deviation metric of the plurality of sequence deviation metrics;
determine a performance metric of each trained machine learning model for each sequence deviation metric; and
select a ranked set of features for a sequence deviation metric that corresponds to a trained machine learning model that has a highest performance metric.

16. The computer program product of claim 15, wherein the one or more instructions further cause the at least one processor to:
select a first number of features from a first ranked set of features to provide a first selected set of features for a first sequence deviation metric; and
select a second number of features from a second ranked set of features to provide a second selected set of features for a second sequence deviation metric;
wherein, the one or more instructions that cause the at least one processor to train the plurality of machine learning models, cause the at least one processor to:
train the machine learning model of the plurality of machine learning models based on:
the first selected set of features for the first sequence deviation metric, and
the second selected set of features for the second sequence deviation metric.

17. The computer program product of claim 16, wherein the first number of features and the second number of features correspond to an input vector size of the machine learning model.

18. The computer program product of claim 15, wherein the one or more instructions further cause the at least one processor to:
perform redundancy reduction procedure on the plurality of features to provide a reduced set of features; and
wherein, the one or more instructions that cause the at least one processor to determine, for each feature of the plurality of features, the plurality of sequence deviation metrics for the first classification and the second classification of the feature, cause the at least one processor to:
determine, for each feature of the reduced set of features, a plurality of sequence deviation metrics for the first classification of the feature and a plurality of sequence deviation metrics for the second classification of the feature.

19. The computer program product of claim 15, wherein, the one or more instructions that cause the at least one processor to determine, for each feature of the plurality of features, the plurality of sequence deviation metrics for the first classification and the second classification of the feature, cause the at least one processor to:
determine a relative cluster distance for each feature of the plurality of features, wherein, the one or more instructions that cause the at least one processor to determine the relative cluster distance for each feature of the plurality of features, cause the at least one processor to:
determine a first cluster center for a first cluster of the first classification of a feature,
determine a second cluster center for a second cluster of the second classification of the feature,
determine a distance between the first cluster center and the second cluster center, and
divide the distance by a sum of standard deviations of the first cluster and the second cluster to provide the relative cluster distance for the feature.

20. The computer program product of claim 15, wherein the plurality of sequence deviation metrics comprises at least one of the following:
root mean square error (RMSE);
mean absolute error (MAE);
mean squared error (MSE);
mean absolute percentage error (MAPE);
symmetric mean absolute percentage error (SMAPE); or
any combination thereof.
